(19) United States
(12) Patent Application Publication
(10) Pub. No.: US 2013/0218866 A1
(43) Pub. Date: Aug. 22, 2013

(54) MULTIMODAL GRAPH MODELING AND COMPUTATION FOR SEARCH PROCESSES

(71) Applicants: Richard J. Qian, Redmond, WA (US); Xiaodong Fan, Sammamish, WA (US)

(72) Inventors: Richard J. Qian, Redmond, WA (US); Xiaodong Fan, Sammamish, WA (US)

(73) Assignee: Microsoft Corporation, Redmond, WA (US)

(21) Appl. No.: 13/400,130

(22) Filed: Feb. 20, 2012

(51) Int. Cl. G06F 17/30

(52) U.S. Cl. 707/714; 707/E17.017

(57) ABSTRACT

Architecture that includes a multimodal graph modeling and computation system employed in a search framework. The framework utilizes entities to diversify and explore the results page. The multimodal graph modeling paradigm can include web modeling by way of a click graph, a web graph, a social graph, a geospatial graph, and an entity graph, for example. These graphs are then joined based on common properties such as links, clicks, and document entities. Computation can then be performed over the joined graphs to generate a related entity list and a related page list. These lists are then processed by a recommendation engine to provide recommendations to the user.

### BACKGROUND

The vast amounts of data being created and stored can be a significant benefit to those who want to use the data and can actually obtain the desired data for different purposes. However, such vast amounts show no sign of diminishing, and thus, present new problems for systems designed to enable the user in finding the data of interest. Search engines are continually evolving to address this problem; however, searching introduces its own complexities. For example, the capability for improved understanding of the semantic intent of the user (via the user query) and to assist the user to refine ambiguous queries is one motivation for improvements in search engines. In another example, mapping a query “panda” to panda as an animal, restaurant chain, and antivirus software, introduces inefficiency and negatively impacts the user experience. Another motivation for improved searching is to promote the diversity of search engine results page (SERP) results with a convenient way to navigate and find the most relevant result (especially for ambiguous queries). For example, the ability to cluster the results for the query “panda” into web document groups about Giant Panda, Panda Express, and Panda Antivirus, would be a desirable capability.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a multimodal graph modeling and computation system employed in a search framework. The framework utilizes entities to diversify and explore the results page. The multimodal graph modeling paradigm can include web modeling by way of a click graph, a web graph, a social graph, a geospatial graph, and an entity graph, for example. These graphs are then joined based on common properties such as links, clicks, and document entities. Computation can then be performed over the joined graphs to generate a related entity list and a related page list. These lists are then processed by a recommendation engine to provide recommendations to the user.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system that employs multimodal graph creation and computation in accordance with the disclosed architecture.

FIG. 3 illustrates a method in accordance with the disclosed architecture.

FIG. 4 illustrates further aspects of the method of FIG. 3.

FIG. 5 illustrates an alternative method in accordance with the disclosed architecture.

FIG. 6 illustrates further aspects of the method of FIG. 5.

FIG. 7 illustrates a block diagram of a computing system that executes multimodal graph modeling and computation in accordance with the disclosed architecture.

### DETAILED DESCRIPTION

The disclosed architecture includes a multimodal graph modeling and computation system employed in a search framework. The framework utilizes entities to diversify and explore the results page. The multimodal graph modeling paradigm can include web modeling by way of a click graph, a web graph, a social graph, a geospatial graph, and an entity graph, for example. These graphs are then joined based on common properties such as links, clicks, and document entities. Computation can then be performed over the joined graphs to generate a related entity list and a related page list. These lists are then processed by a recommendation engine to provide recommendations to the user.

Moreover, by multimodal graph modeling, the above graphs can be joined. For example, the click graph and web graph can be joined via clicked URLs (uniform resource locators); the web graph can be joined with social/geospatial/entity graphs via the detected entities on the web documents.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

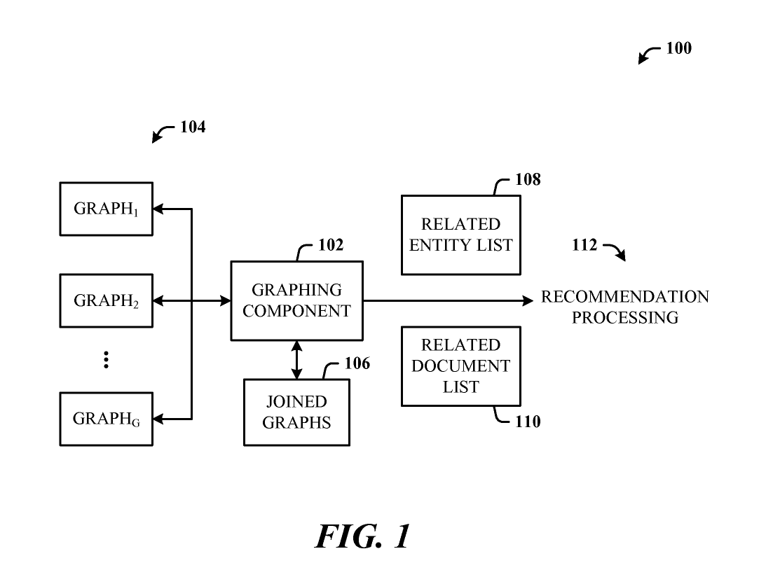

FIG. 1 illustrates a system 100 in accordance with the disclosed architecture. The system 100 can include a graphing component 102 of a search framework that joins graphs 104 of disparate types of web information, performs computations across joined graphs 106, and outputs a related entity list 108 and a related web document list 110 for recommendation processing 112 as part of a search process.

The graphs 104 include a click graph that connects queries with links selected by users on a results page, and a web graph that connects documents via links that include hyperlinks, referrer links, and co-visit links. The graphs 104 include a social graph that connects people entities of social networks and a geospatial graph that connects geospatial entities. The graphs 104 include an entity graph that comprises general entities and associated semantic relationships.

The graphing component 102 joins the graphs 104 based on selected links and detected document entities. The related entity list 108 is created based on distance of entity candidates from a source entity within an entity graph, features for each candidate that include graph features, popularity features, and authority features, and rank of the related entity candidates. The related web document list 110 is created based retrieval of related document candidates, computed graph distance features, and rank of the related document candidates.

The system can further comprise a recommendation engine that performs the recommendation processing of the related entity list and related web document list to output recommendations for presentation via a user experience component. This is described in greater detail hereinbelow.

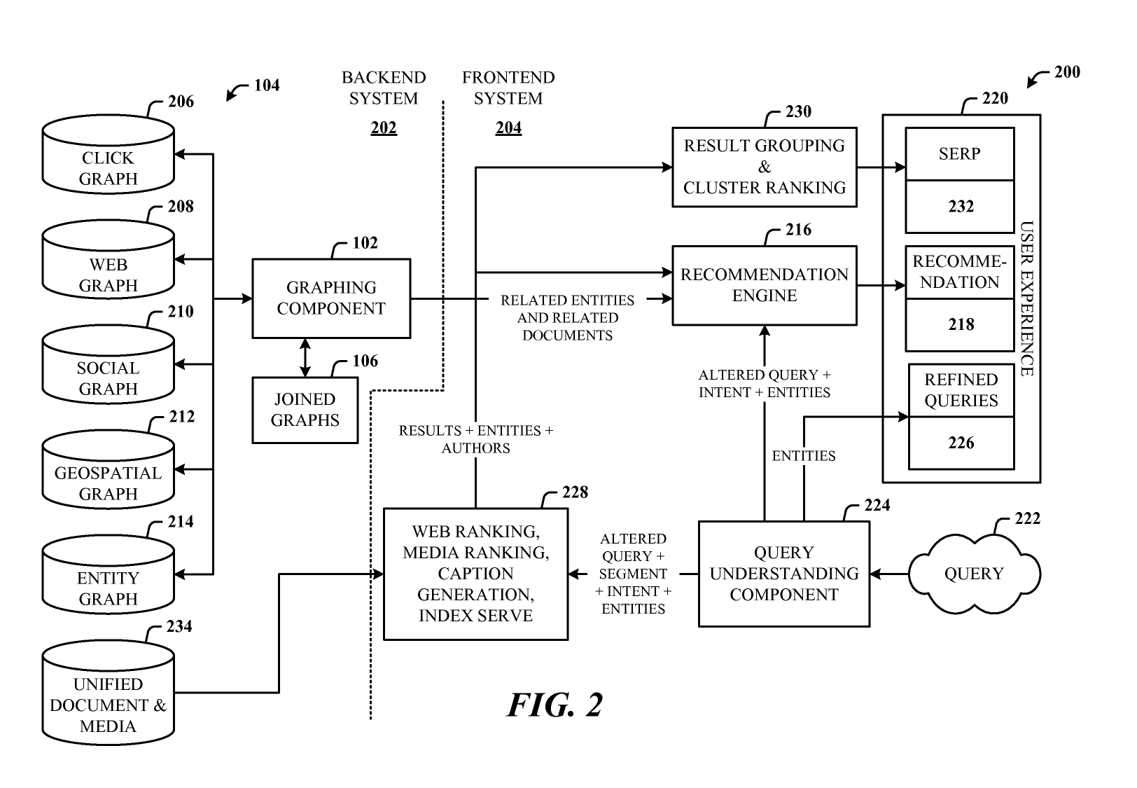

FIG. 2 illustrates a system 200 that employs multimodal graph creation and computation in accordance with the disclosed architecture. In this embodiment, the graphing component 102 and graphs 104 are part of the system 200, which enables SERF diversity and exploration via entities. Entities are carriers of human knowledge and provide a natural way to understand latent objectives of queries and web documents, as well as their semantic relationship. Generally, the system 200 comprises a backend system 202 of components and a frontend system 204 of components. The backend system 202 includes the graphing component 102 that receives as input the disparate graphs 104. The disparate graphs 104 can include a click graph 206, a web graph 208, a social graph 210, a geospatial graph 212, and an entity graph 214. The graphing component 102 joins multiples of the graphs 104 of web information into joined graphs 106, performs computations across the joined graphs 106, and outputs related entities and related web documents for recommendation processing by a recommendation engine 216. The output of the recommendation engine (a component) 216 provides recommendation (data) 218 as part of a user experience component 220.

The backend system 202 facilitates indexing and knowledge generation via fetching/understanding/processing/indexing web documents and, acquiring/extracting entities and conflating the entities into the entity graph 214, joining the web graph 208 (document to document links) and click graph 206 (query to document links) with the entity graph 214 (including the social graph 210 and the geospatial graph 212) by mapping queries and web documents to entities. The backend system 202, via the graphing component 102, performs multimodal graph computation on the web graph 208, click graph 206, and entity graph 214 to generate the related entity and related page lists (108 and 110). That is, for each entity and web document, a list is generated related to entities and pages.

The frontend system 204 includes components that perform entity detection from a query 222 in a query understanding component 224, and recommending refined queries 226 based on the detected entities of the original query via the query understanding component 224, if the query 222 is ambiguous or vague. Additionally, the frontend system 204 facilitates augmentation of the raw query 222 with a segment, intent, and entity information extracted from the raw query 222, and then passing this augmentation into an entity aware ranker 228 to obtain a ranked document list. A result grouping and cluster ranking component 230 provides result grouping on the SERP 232 by clustering returned web documents via the associated dominant entities. The recommendation engine 216 provides the recommendation 218 by combining related entities, related pages, and results, entities, and authors from the ranker 228. The ranker 228 also receives input from a store 234 of unified documents and media.

With respect to indexing and knowledge generation in the backend system 202, SERP result grouping and recommendation can rely on stamping web documents with known entities. However, other algorithms can be employed to join web documents with entities. For instance, the title, anchor stream, and click stream of the web documents can be matched with the entity index to detect entities of the web documents. Additionally, the click graph, which connects the queries with the URLs that users click on SERP, can be used to propagate the detected entities between queries and web documents.

Multimodal graph modeling models the web using at least the following graphs:

The web graph connects web documents via hyperlinks, which web graph is constructed by the crawler when outlinks (links pointing away) from the web pages are parsed and the graph stored in a web graph repository.

The social graph connects people entities via friendship, follow, retweet, reply, etc., properties. One main source of the social graph is form social networks such as Facebook™, Twitter™, Linkedin™, etc., as well as authorship extraction from news, Q&A (question and answer) websites, blogs, forums, reviews, content farm sites, and so on.

The geospatial graph connects geospatial entities via containing, adjacent and related relationships.

The entity graph includes general entities (e.g., movies, songs, events) as well as the associated semantic relationships.

Multimodal graph modeling also includes joining the above graphs. For example, the click graph and web graph can be joined via clicked URLs; the web graph can be joined with the social graph, geospatial graph, and entity graph via entities detected on the web documents.

The multimodal graph computation platform performs computations across these joined graphs. Multimodal graph computation generates the related entity list and related page list.

Following is a description of generation for the related entities list. For each entity in the entity store, first, all the related entity candidates that are within a certain number of hops from the source entity on the entity graph are retrieved. For each related entity candidate, a set of features is computed that describe the candidate's relatedness to the source entity: the features can include entity graph distance between two entities, web graph distance between the reference web documents of two entities (the web graph distance considers both hyperlinks and co-visit links), etc. These graph features, as well as the features to describe the popularity and authority of the related entity candidate, are input to a ranker algorithm to rank the related entity candidates according to ranking scores. A threshold is then imposed on the ranking scores to obtain a pruned related entity list.

With respect to related pages, for each page, all the related page candidates that are co-linked (via hyperlinks), co-visited, clicked for the same query, or share the same or related detected entities, are retrieved. Page static rank, and/or click/impression count can be used to focus on the pages that users are mostly interested in. Graph distance features can again be computed from the corresponding web graph, click graph, and entity graph, and a ranker algorithm is trained to compute the final relatedness metrics in order to rank the related pages.

The topic specific rank for each author can also be computed to find the experts for each topic. A list of frequently recurring entities is extracted from the past articles written by the expert, the expert-entity rank score is computed based on the recurring frequency of the entity weighted by the web document static ranks, and the top N entities for each expert are obtained. An inverted index is then constructed that maps each entity to a ranked list of experts, ordered by the expert-entity rank scores.

The query understanding component 224 includes a set of technologies, ranging from domain/segmentation detection (e.g., “Is the query about News, Multimedia, Local, Entertainment, or Events, etc.?”), query intent detection (e.g., “Is the user interested in the biography, picture, gossip information of a celebrity in the Entertainment segment?”), entity extraction (e.g., “harry potter pacific science center”→[MovieTitle=harry potter, MovieTheater=pacific science center]), and entity resolution (e.g., “harry potter”→Harry Potter and the Deathly Hallows—Part 2). Query understanding models can be, in general, hosted in a query annotation service, which annotates queries with the segment, intent, and entity information. Thus, entity detection is performed in the query, and can be implemented as matching and ranking entities from the entity index.

Query understanding addresses document/segment classification, entity extraction, entity resolution and, context understanding and personalization. Domain/segment classification provides the capability to absorb the segment specific features used in vertical rankers. Thus, segment ranking is employed to detect the segment(s) to which a query belongs. Entity extraction is associated with the segment specific entity search. In addition to referring an entity directly by its name, a query often describes an entity via its attributes (e.g., location and cuisine of a restaurant, genre or director of a movie, etc.). Entity extraction identifies these entity attribute values (also commonly called facets or slots).

With respect to entity resolution, given a query, a canonical entity identifier (ID) or a set of canonical entity ID's can be assigned by an entity resolver, such that the ranker can be agnostic to spelling variations (e.g., hundreds of spellings for personal name) and synonyms (e.g., “blue people movie” for a named movie).

With respect to context understanding and personalization, contextual information such as location can be utilized. Searching for “italian restaurant” in Boston should yield different results than the same search in Seattle. Other contextual information includes session information (e.g., “action movie by tom cruise” followed by “and drew Barrymore”) and personal preference.

With respect to segment classification, data-driven, statistical approaches are applied for domain/segment classification in query understanding. Domain data are obtained by leveraging a query explorer platform (QEP), which is a bipartite query/URL click graph. Positive URLs are selected by a classifier developer, either manually or via a graph walk starting from a set of positive seed queries. Positive examples of queries can be obtained, in turn, by selecting those that result in the dominant clicks to the positive URLs, and negative training data can be obtained by randomly sampling the queries in QEP initially. After an initial classifier has been trained, the negative training set can be refined to include those close to the classification boundary.

With respect to entity extraction, semi-Markov conditional random fields (SMCRF, codename BITE) can be employed to entity extraction. Other alternatives include, but are not limited to, linear chain CRF (LCCRF) and probabilistic context free grammar (PCFG).

With respect to entity resolution, mini-index-ranker is a technology applied for entity resolution. A mini-index-ranker can be viewed as a relevance ranker for entities of a specific type (instead of documents). The ranker uses the click boost stream as the primary dynamic feature.

With respect to context understanding and personalization, a geo-code can e associated with every query. If the location information is explicitly stated in the query, the location entity from the entity extractor can be sent to an LES (location entity service) to obtain the geo-spatial information. If the explicit location is not available, implicit location information is obtained according to user's preference setting and reverse-IP lookup. The geo-spatial information is available in a query service response, which is used by a dynamic ranker.

With respect to the result grouping and cluster ranking component 230, document entities provide the latent classes to group the web documents in the SERP 232. Treating each individual entity as a single cluster can be sufficient; an agglomerative clustering algorithm can also be used to recursively merge closely related clusters, if desired. The web document is then assigned to each cluster based on the ownership of the corresponding entities in the cluster. Each cluster forms the result group.

Rather than directly ranking the web documents, the result groups can be ranked. The ranking signals can include the maximum/minimum (max/min) rank scores of documents in the group, max/min matching scores between the query entities and the underlying entities of the result group, size of the cluster, etc. In order to help users navigate the results of the SERP 232 more conveniently, each result group can be displayed on top of the SERP 232 with some entity information of the cluster.

The recommendation engine 216 assists users in exploring more related information, relative to the user's original query and the returned web documents in SERP 232. Recommendations from various sources, described below, can be combined.

Related entities: After detecting the entities from the query, related entities that are pre-computed under multimodal graph computation can be recommended. Similarly, for each returned web document in the SERP 232, related entities relative to the detected entities from the web document, can be recommended as well. To assist users in navigating the recommended entities, the suggested entities can be clustered as well as an entity graph path between the suggested entity and source entity can be used to explain the relationship. Clicking on these suggested entities leads to issuing corresponding queries.

Related pages: In addition to entities, pages related to the returned documents in the SERP 232 can be directly recommended, using the related pages pre-computed under multimodal graph computation. This provides users with an efficient way to view more related documents without issuing additional queries first, as in the case of related entities.

Documents written by the same author: Since author entities are extracted from the web document, the authorship information is shown and users are allowed to search for more documents written by the same author, as one way to recommend related documents. Links are also provided for users to subscribe to RSS (really simply syndication) feeds (or other types of web feeds) of the author, or follow the author on a social network. This feature uses successful conflating of the people entities from various sources.

Entities from author expertise: Mapping between entities and experts is described above. If the document author is detected as an expert, the document author expertise entities can be suggested as additional recommendations. Since experts usually do not write articles on random entities, these suggested entities are often highly related to the user query and/or the web document in the SERP written by that expert.

Related experts and entities: With the detected entity of the document in the SERP 232, related experts can be retrieved using the entity-to-expert mapping list pre-computed under multimodal graph computation. The profile information for each related expert is displayed in a popup window in response to hovering, for example, over the recommended expert, which contains links to top/recent documents written by the expert, as well as additional entities from the associated expertise.

Thus, in general, the recommendation engine 216 operates on the following features: cross domain, where the recommendation list contains entities, documents, and experts, and semantics, where pivoting on the entity and entity graph, semantic explanation is provided as to why certain entities, documents, and experts are recommended.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

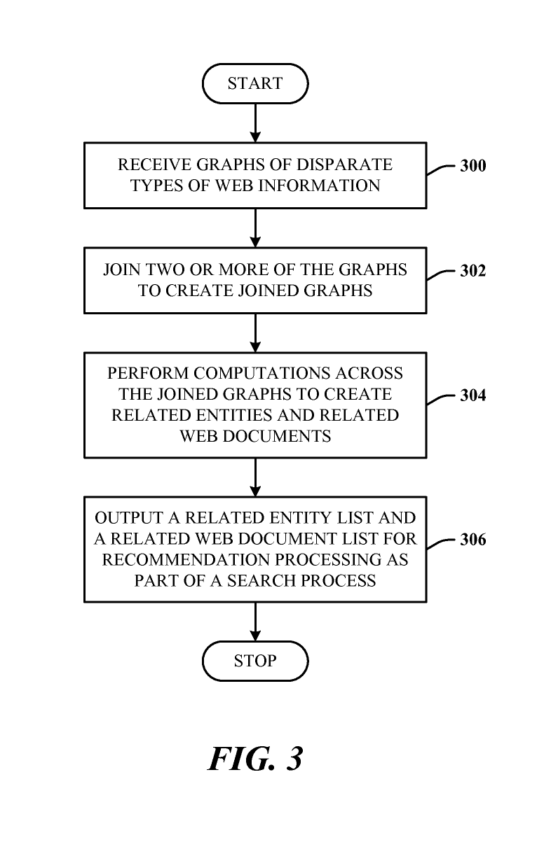

FIG. 3 illustrates a method in accordance with the disclosed architecture. At 300, graphs of disparate types of web information are received. At 302, two or more of the graphs are joined to create joined graphs. At 304, computations are performed across the joined graphs to create related entities and related web documents. At 306, a related entity list and a related web document list are output for recommendation processing as part of a search process.

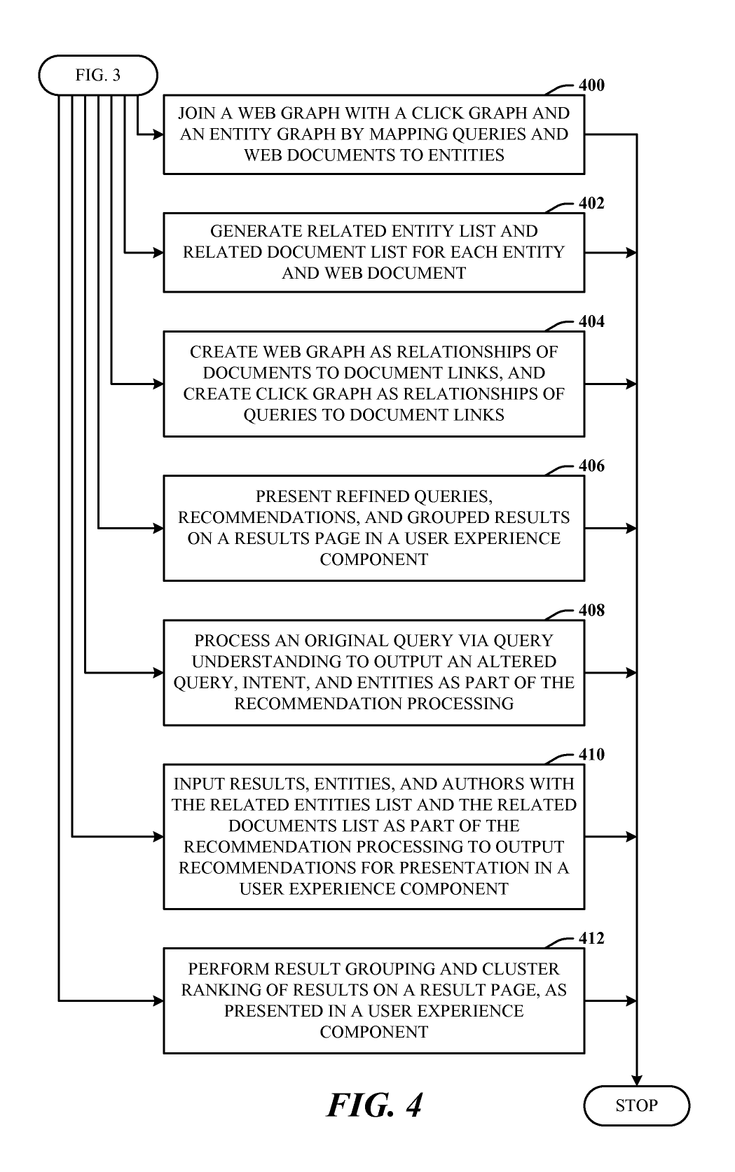

FIG. 4 illustrates further aspects of the method of FIG. 3. Note that the flow indicates that each block can represent a step that can be included, separately or in combination with other blocks, as additional aspects of the method represented by the flow chart of FIG. 3. At 400, a web graph is joined with a click graph and an entity graph by mapping queries and web documents to entities. At 402, the related entity list and related document list are generated for each entity and web document. At 404, a web graph as relationships of documents to document links is created, and a click graph as relationships of queries to document links is created. At 406, refined queries, recommendations, and grouped results on a results page are presented in a user experience component. At 408, an original query is processed via query understanding to output an altered query, intent, and entities as part of the recommendation processing. At 410, results, entities, and authors are input with the related entities list and the related documents list as part of the recommendation processing to output recommendations for presentation in a user experience component. At 412, result grouping and cluster ranking of results is performed on a results page, as presented in a user experience component.

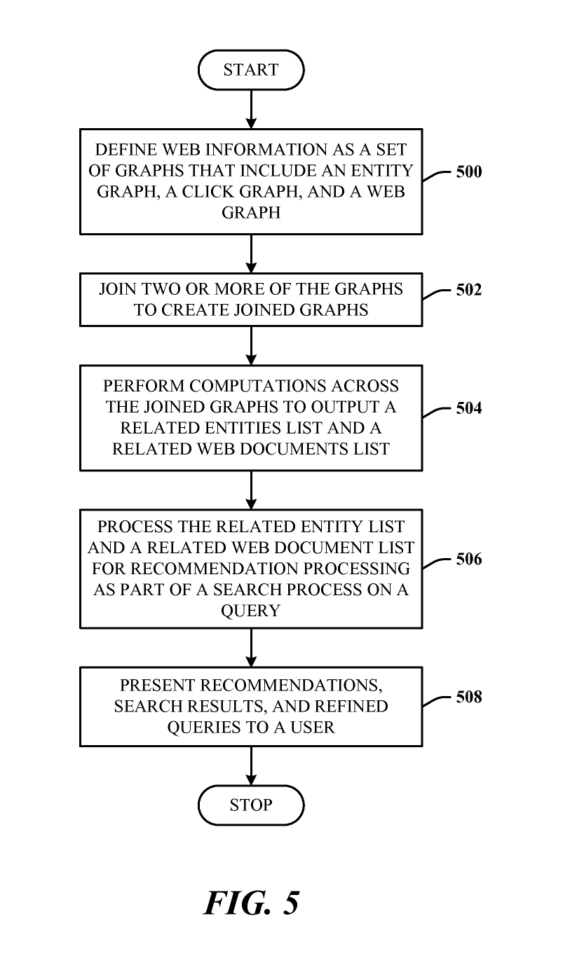

FIG. 5 illustrates an alternative method in accordance with the disclosed architecture. At 500, web information is defined as a set of graphs that include an entity graph, a click graph, and a web graph. At 502, two or more of the graphs are joined to create joined graphs. At 504, computations are performed across the joined graphs to output a related entities list and a related web documents list. At 506, the related entity list and a related web document list are processed for recommendation processing as part of a search process on a query. At 508, recommendations, search results, and refined queries are presented to a user.

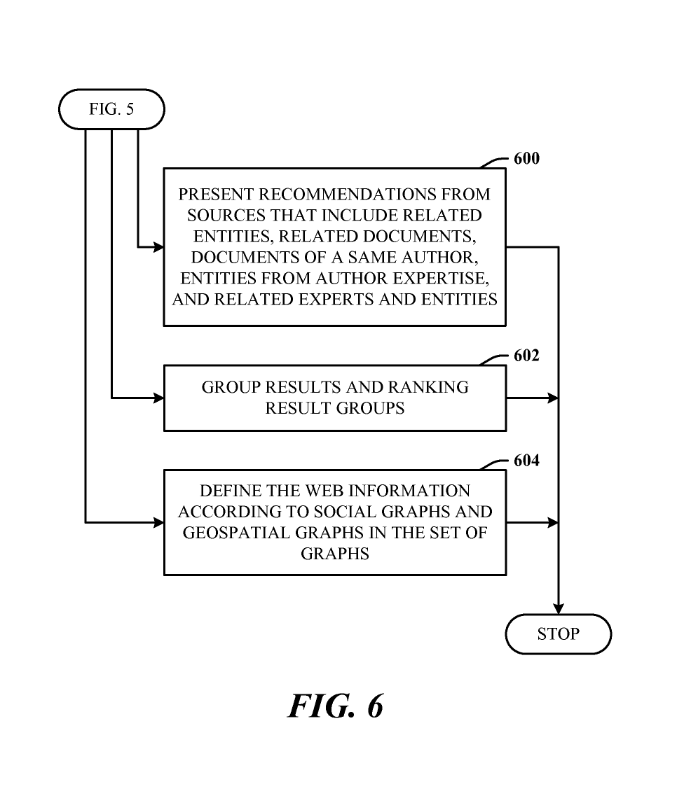

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, recommendations from sources that include related entities, related documents, documents of a same author, entities from author expertise, and related experts and entities are presented. At 602, results are grouped and the result groups are ranked. At 604, the web information is further defined according to social graphs and geospatial graphs in the set of graphs.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

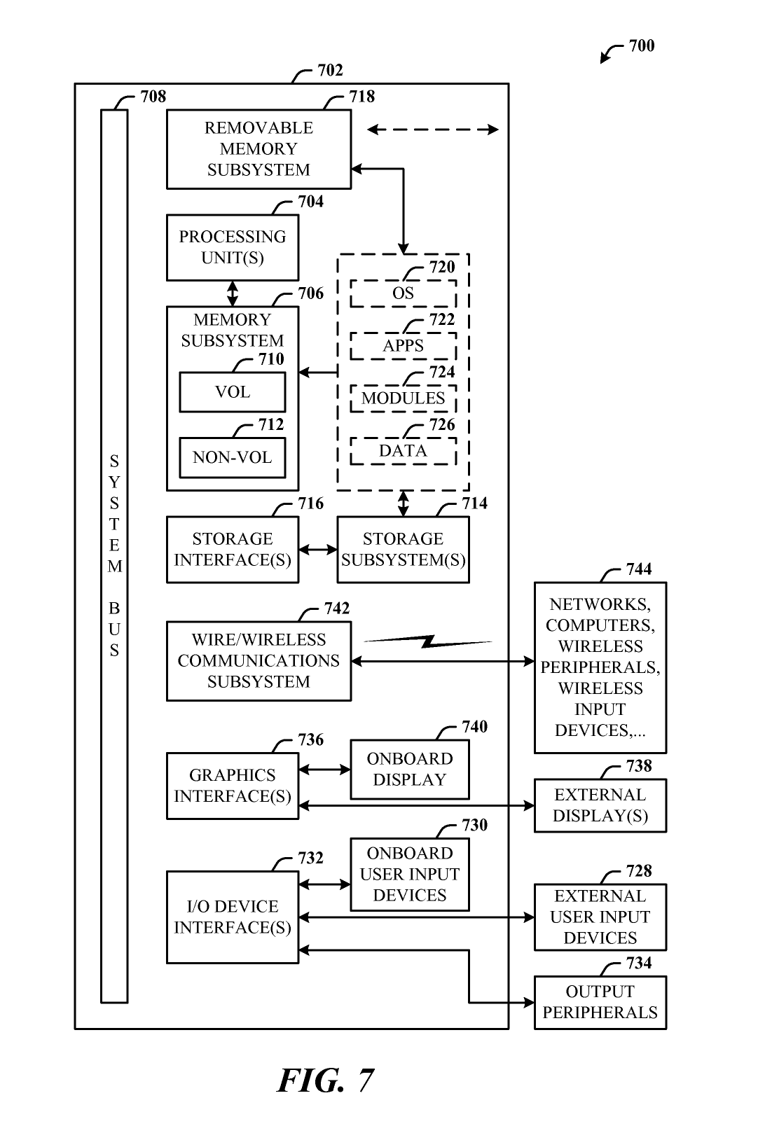

Referring now to FIG. 7, there is illustrated a block diagram of a computing system 700 that executes multimodal graph modeling and computation in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor- based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include the entities and components of the system 100 of FIG. 1, the entities and components of the system 200 of FIG. 2, and the methods represented by the flowcharts of FIGS. 3-6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 702 and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse, and using voice commands via speech recognition, for example. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example.

These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise- wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a graphing component of a search framework that joins graphs of disparate types of web information, performs computations across the joined graphs, and outputs a related entity list and a related web document list for recommendation processing as part of a search process; and
a processor that executes computer-executable instructions associated with the graphing component.

2. The system of claim 1, wherein the graphs include a click graph that connects queries with links selected by users on a results page, and a web graph that connects documents via links that include hyperlinks, referrer links, and co-visit links.

3. The system of claim 1, wherein the graphs include a social graph that connects people entities of social networks and a geospatial graph that connects geospatial entities.

4. The system of claim 1, wherein the graphs include an entity graph that comprises general entities and associated semantic relationships.

5. The system of claim 1, wherein the graphing component joins the graphs based on selected links and detected document entities.

6. The system of claim 1, further comprising a recommendation engine that performs the recommendation processing of the related entity list and related web document list to output recommendations for presentation via a user experience component.

7. The system of claim 1, wherein the related entity list is created based on distance of entity candidates from a source entity within an entity graph, features for each candidate that include graph features, popularity features, and authority features, and rank of the related entity candidates.

8. The system of claim 1, wherein the related web document list is created based retrieval of related document candidates, computed graph distance features, and rank of the related document candidates.

9. A method, comprising acts of:
receiving graphs of disparate types of web information;
joining two or more of the graphs to create joined graphs;
performing computations across the joined graphs to create related entities and related web documents;
outputting a related entity list and a related web document list for recommendation processing as part of a search process; and
utilizing a processor that executes instructions stored in memory to perform at least one of the acts of receiving, joining, performing, or outputting.

10. The method of claim 9, further comprising joining a web graph with a click graph and an entity graph by mapping queries and web documents to entities.

11. The method of claim 9, further comprising generating the related entity list and related document list for each entity and web document.

12. The method of claim 9, further comprising creating a web graph as relationships of documents to document links, and creating a click graph as relationships of queries to document links.

13. The method of claim 9, further comprising presenting refined queries, recommendations, and grouped results on a results page in a user experience component.

14. The method of claim 9, further comprising processing an original query via query understanding to output an altered query, intent, and entities as part of the recommendation processing.

15. The method of claim 9, further comprising inputting results, entities, and authors with the related entities list and the related documents list as part of the recommendation processing to output recommendations for presentation in a user experience component.

16. The method of claim 9, further comprising performing result grouping and cluster ranking of results on a result page, as presented in a user experience component.

17. A method, comprising acts of:
defining web information as a set of graphs that include an entity graph, a click graph, and a web graph;
joining two or more of the graphs to create joined graphs;
performing computations across the joined graphs to output a related entities list and a related web documents list;
processing the related entity list and a related web document list for recommendation processing as part of a search process on a query;
presenting recommendations, search results, and refined queries to a user; and
utilizing a processor that executes instructions stored in memory.

18. The method of claim 17, further comprising presenting recommendations from sources that include related entities, related documents, documents of a same author, entities from author expertise, and related experts and entities.

19. The method of claim 17, further comprising grouping results and ranking result groups.

20. The method of claim 17, further comprising defining the web information according to social graphs and geospatial graphs in the set of graphs.
